(19) United States
(12) Patent Application Publication
(10) Pub. No.: US 2006/0108927 A1
(43) Pub. Date: May 25, 2006

(54) High-pressure discharge lamp

(75) Inventors: Klaus Gunther, Neu Lutterow (DE); Thomas Hartmann, Berlin (DE); Gunther Hirschmann, Munchen (DE); Arnulf Rupp, Oberhaching (DE); Bernhard Siessegger, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/272,066

(22) Filed: Nov. 14, 2005

(30) Foreign Application Priority Data
Nov. 19, 2004 (DE) 10 2004 056 004.8

(51) Int. Cl. H01J 17/44

(52) U.S. Cl. 313/594

(57) ABSTRACT

The invention relates to a high-pressure discharge lamp having a light-transmitting discharge vessel, which includes at least one sealed end and a starting aid, the starting aid being arranged on the at least one sealed end and being designed to be opaque.

### I. TECHNICAL FIELD

The invention relates to a high-pressure discharge lamp having a light-transmitting discharge vessel, which comprises at least one sealed end and a starting aid.

### II. BACKGROUND ART

A high-pressure discharge lamp of this type is disclosed, for example, in U.S. Pat. No. 6,429,588. This document describes a high-pressure discharge lamp having a light-transmitting, ceramic discharge vessel which has two sealed ends. An electrically conductive coating in strip form, which extends in the longitudinal direction of the discharge vessel and serves as a starting aid, is arranged on the discharge vessel.

### III. DISCLOSURE OF THE INVENTION

It is an object of the invention to provide a high-pressure discharge lamp of the generic type with an improved starting aid.

The high-pressure discharge lamp according to the invention has a light-transmitting discharge vessel with at least one sealed end and a starting aid, this starting aid, according to the invention, being designed to be opaque and being arranged on the at least one sealed end of the discharge vessel. This ensures that it is impossible for any light which would interfere with the imaging of the discharge arc in an optical system to escape from the at least one sealed end of the discharge vessel. This is particularly important for high-pressure discharge lamps which are used as light source in a motor vehicle headlamp or other optical system. Moreover, it has been found that a starting aid which is arranged only on the at least one sealed end of the discharge vessel functions just as well as the starting aid described in the prior art cited above. Furthermore, the starting aid according to the invention has the advantage of not causing any light shadowing in the middle section of the discharge vessel, which is crucial for the emission of light.

The invention can particularly advantageously be applied, for example, to halogen metal vapor high-pressure discharge lamps for motor vehicle headlamps, the discharge vessel of which comprises a transparent sapphire tube or another transparent material, which for manufacturing reasons has two sealed ends made from polycrystalline aluminum oxide ceramic. The polycrystalline aluminum oxide ceramic is translucent but not transparent like the sapphire tube, and therefore causes disruptive scattered light, the occurrence of which is significantly reduced by the starting aid according to the invention. It is preferable for the opaque starting aid to extend over the entire circumference of the at least one sealed end of the discharge vessel, and particularly preferably also over that surface of the at least one sealed end of the discharge vessel which runs obliquely or perpendicularly with respect to the longitudinal axis of the discharge vessel.

The starting aid of the high-pressure discharge lamp according to the invention is preferably designed as an opaque, metallic coating on the outer side of the at least one sealed end of the discharge vessel or as an opaque, metallic cap.

Metals are preferably suitable for the coating or cap, since they are electrically conductive and ensure a good absorption of light even when applied in a relatively low thickness. The coating may consist of one single metal or alternatively may comprise a layer sequence of different metals. The melting point of the metal or metals must be above the temperature of the discharge vessel while the lamp is operating, and moreover the metal or metals must be sufficiently corrosion-resistant at the abovementioned temperature.

The opaque, metallic coating or cap of at least one sealed end of the discharge vessel can advantageously be connected to the voltage output of a starting device, in order for the gas discharge in the discharge vessel to be ignited initially between the abovementioned coating or cap and the lamp electrode which is fixed in this sealed end of the discharge vessel. In this case, the abovementioned coating or cap serves as an auxiliary electrode. The discharge channel then extends as far as the second lamp electrode. Alternatively, however, the opaque, metallic coating or cap of a first sealed end of the discharge vessel may be electrically conductively connected to a supply conductor which leads out of a second sealed end of the discharge vessel, in order to ignite the gas discharge in the discharge vessel between the abovementioned coating or cap of the first sealed end and the lamp electrode fixed in the first sealed end of the discharge vessel. In this case, the ignition voltage is fed to the abovementioned coating or cap of the first sealed end and to the lamp electrode fixed in the second sealed end of the discharge vessel. As a further alternative, the opaque, metallic coating or cap can also be used without being connected to a lamp electrode or starting device. In this case, the coating or cap serves as a purely capacitive starting aid. Furthermore, it is possible for the opaque, metallic coatings or caps at both ends of the discharge vessel to be connected to one another by a wire or a narrow metallic strip on the outer side of the middle section of the discharge vessel, in order to further lower the ignition voltage of the lamp.

### IV. BRIEF DESCRIPTION OF THE DRAWINGS

The invention is explained in more detail below on the basis of a preferred exemplary embodiment, in which:

FIG. 1 shows a cross section through the discharge vessel of a high-pressure discharge lamp with a starting aid designed as an opaque, metallic coating, in accordance with the first exemplary embodiment of the invention,

FIG. 2 shows the high-pressure discharge lamp illustrated in FIG. 1 with an alternative form of contact-connection for the starting aid,

FIG. 3 shows the high-pressure discharge lamp illustrated in FIGS. 1 and 2 with outer bulb and lamp base as well as a starting aid which is not contact-connected, in accordance with the third exemplary embodiment,

FIG. 4 shows the high-pressure discharge lamp illustrated in FIG. 1 with a starting aid in accordance with the fourth exemplary embodiment,

FIG. 5 shows the high-pressure discharge lamp illustrated in FIG. 3 with a starting aid in accordance with the fifth exemplary embodiment of the invention, which is directly contact-connected to a starting device accommodated in the lamp base,

FIG. 6 shows the high-pressure discharge lamp illustrated in FIG. 1 with a starting aid designed as a metallic cap.

### V. BEST MODE FOR CARRYING OUT THE INVENTION

The lamp which is diagrammatically depicted in the figures is a mercury-free high-pressure discharge lamp with a power consumption of 25 watts to 35 watts, which is intended for use in a motor vehicle headlamp. The discharge vessel 1 of this lamp has a tubular, cylindrical middle section 10, which consists of a transparent material, preferably of sapphire or yttrium aluminum garnet. The open ends of the section 10 are each closed off by a ceramic closure piece 11 and 12 made from polycrystalline aluminum oxide. The internal diameter of the cylindrical section 10 is 1.5 millimeters. Two electrodes 2, 3 are arranged on the longitudinal axis of the discharge vessel 1, in such a way that their discharge-side ends project into the interior of the middle, cylindrical section 10 and are at a distance of 4.2 millimeters from one another. The ionizable filling which is enclosed in the discharge vessel 1 consists of xenon with a cold filling pressure in the range from 0.3 Megapascal to 1 Megapascal, and in total 4 milligrams of the iodides of sodium, dysprosium, holmium, thulium and thallium. The electrodes 2 and 3 are each connected via a supply conductor 4 and 5, respectively, to an electrical terminal 16 and 17, respectively, of the lamp base 15. The discharge vessel 1 is surrounded by a light-transmitting outer bulb 14. Both sealed ends 11, 12 of the discharge vessel 1 are provided on their outer side with a metallic coating 110, 120 extending over their entire circumference. The metallic coatings 110, 120 are opaque and also extend over those surfaces 11a, 12a of the sealed ends 11, 12 at the end sides of the sapphire tube 10 which run obliquely or perpendicularly with respect to the longitudinal axis of the discharge vessel.

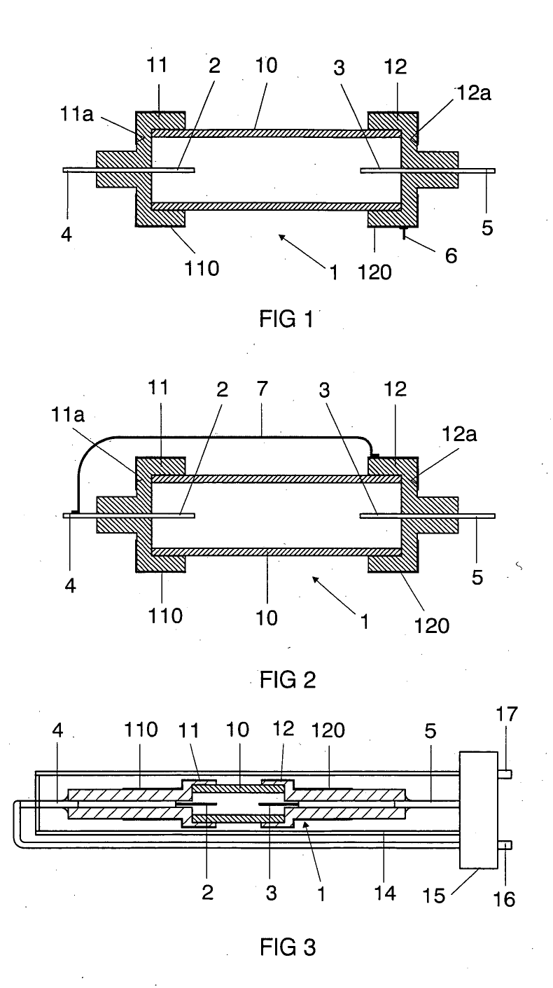

In accordance with the first exemplary embodiment of the invention illustrated in FIG. 1, the metallic coating 120 of the first sealed end 12 is designed as an auxiliary starting electrode which is connected to the high-voltage output of a starting device accommodated in the lamp base 15, for example with the aid of a wire 6 which is guided back to the lamp base 15 or in some other suitable way. It is assumed that the ignition of the gas discharge in the discharge vessel 1 is initially effected by a dielectric barrier discharge between the coating 120 and the electrode 3, followed by a sparkover between the two electrodes 2 and 3.

In accordance with the second exemplary embodiment of the invention, illustrated in FIG. 2, the metallic coating 120 of the first sealed end 12 is electrically conductively connected to the supply conductor 4 projecting out of the second sealed end 11, for example with the aid of a wire 7 or a strip-like coating on the outer side of the discharge vessel 1 or on the inner side of the outer bulb 14. As a result, the gas discharge in the discharge vessel 1 is ignited between the coating 120 and the electrode 3.

The third exemplary embodiment of the invention illustrated in FIG. 3 is the same high-pressure discharge lamp as in the first two exemplary embodiments. Therefore, the same reference designations have also been used for identical parts. However, FIG. 3 additionally also illustrates the outer bulb 14 and the lamp base 15 of the high-pressure discharge lamp. Unlike in the first two exemplary embodiments, the opaque, metallic coatings 110, 120 of the sealed ends 11, 12 are not electrically contact-connected in this embodiment. In accordance with the third exemplary embodiment, these coatings 110, 120 serve as a capacitive starting aid.

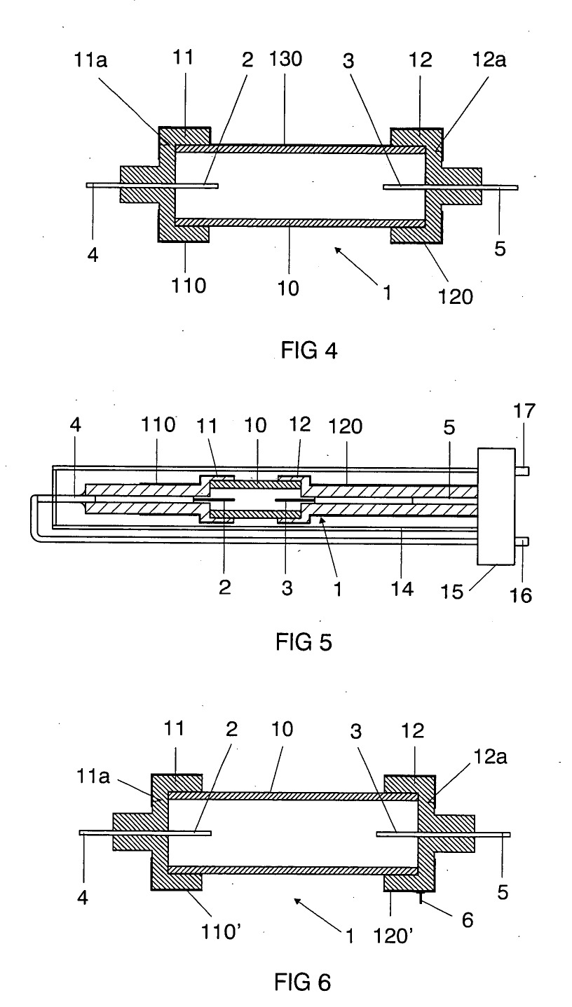

In the fourth exemplary embodiment, diagrammatically depicted in FIG. 4, the opaque, metallic coatings 110, 120 of the sealed ends 11, 12 of the discharge vessel 1 are connected to one another by a narrow, electrically conductive strip 130 on the outer side of the middle section 10 of the discharge vessel 1. The strip 130 is designed as a light-transmitting or metallic coating. Alternatively, however, the coatings 110, 120 may also be electrically connected with the aid of a wire. The outer bulb and the lamp base have been omitted from the illustration, as also in FIGS. 1 and 2, for the sake of clarity.

In the fifth exemplary embodiment of the invention illustrated in FIG. 5, the sealed end 12 of the discharge vessel 1 on the base side has been extended sufficiently far for it to project into the lamp base 15. The opaque, metallic coating 120 of the sealed end 12 extends all the way into the lamp base 15, where it is directly electrically contact-connected to the voltage output of a starting device accommodated in the lamp base 15.

In the sixth exemplary embodiment of the invention, diagrammatically depicted in FIG. 6, the sealed ends 11, 12 of the discharge vessel 1 are each provided with an opaque, metallic cap 110′, 120′. The caps 110′, 120′ are clamp-fitted onto the ends 11, 12. These cylindrical caps 110′, 120′ extend over the entire circumference of the sealed ends 11, 12, and the base of the caps 110′, 120′, at the respective end side of the discharge vessel 1, bears against that surface 11a or 12a of the respective sealed end 11 or 12, respectively, which runs perpendicularly with respect to the longitudinal axis of the discharge vessel. Apertures for the supply conductors 4 and 5 are provided in the base of the caps 110′, 120′. The cap 120′ is connected to a starting device accommodated in the lamp base via a wire 6 which leads back to the lamp base (not shown in FIG. 6). As is also diagrammatically depicted in FIG. 3, this high-pressure discharge lamp has an outer bulb 14 and a lamp base 15.

1. A high-pressure discharge lamp having a light-transmitting discharge vessel, which comprises at least one sealed end and a starting aid, wherein the starting aid is arranged on the at least one sealed end and is designed to be opaque.

2. The high-pressure discharge lamp as claimed in claim 1, wherein the discharge vessel has two sealed ends consisting of a polycrystalline aluminum oxide ceramic, and the section of the discharge vessel which is arranged between these ends consists of a transparent material, preferably of sapphire.

3. The high-pressure discharge lamp as claimed in claim 1, wherein the starting aid is designed as an opaque, metallic coating.

4. The high-pressure discharge lamp as claimed in claim 1, wherein the starting aid is designed as an opaque, metallic cap.

5. The high-pressure discharge lamp as claimed in claim 3, wherein the opaque, metallic coating or cap of the at least one sealed end can be connected to the voltage output of a starting device for igniting the gas discharge in the discharge vessel.

6. The high-pressure discharge lamp as claimed in claim 3, wherein the opaque, metallic coating or cap of a first sealed end of the discharge vessel is electrically conductively connected to a supply conductor which leads out of a second sealed end of the discharge vessel.

7. The high-pressure discharge lamp as claimed in claim 3, wherein the coating or cap extends over the entire circumference of the at least one sealed end of the discharge vessel.

8. The high-pressure discharge lamp as claimed in claim 6, wherein the opaque, metallic coating or cap additionally extends onto the surface, which runs obliquely or perpendicularly with respect to the longitudinal axis of the discharge vessel, of the at least one sealed end of the discharge vessel.

9. The high-pressure discharge lamp as claimed in claim 4, wherein the opaque, metallic coating or cap of the at least one sealed end can be connected to the voltage output of a starting device for igniting the gas discharge in the discharge vessel.

10. The high-pressure discharge lamp as claimed in claim 4, wherein the opaque, metallic coating or cap of a first sealed end of the discharge vessel is electrically conductively connected to a supply conductor which leads out of a second sealed end of the discharge vessel.

11. The high-pressure discharge lamp as claimed in claim 4, wherein the coating or cap extends over the entire circumference of the at least one sealed end of the discharge vessel.
